(19) United States
(12) Patent Application Publication
(10) Pub. No.: US 2016/0006940 A1
(43) Pub. Date: Jan. 7, 2016

(54) DIGITAL VIDEO RECORDER AIMING DEVICE

(71) Applicant: John Drew Hurst, Wake Forest, NC (US)

(72) Inventor: John Drew Hurst, Wake Forest, NC (US)

(21) Appl. No.: 14/851,379

(22) Filed: Sep. 11, 2015

Related U.S. Application Data
(63) Continuation-in-part of application No. 13/420,889, filed on Mar. 15, 2012, now Pat. No. 9,160,903.
Application No. 13/420,889 is a continuation-in-part of application No. 12/102,001, filed on Apr. 13, 2008, now abandoned.
Application No. 12/102,001 is a continuation-in-part of application No. 12/027,257, filed on Feb. 6, 2008, now abandoned.

(51) Int. Cl. H04N 5/232; G03B 13/04; H04N 5/225

(52) U.S. Cl. CPC H04N 5/23293; H04N 5/2251; G03B 13/04; H04N 5/23296

(57) ABSTRACT

The present invention relates to an aiming device for a digital video recorder (DVR). An open frame with an attachment means is mounted to the DVR such that one can see what the DVR will record through the open frame, yet still be able to view the non-recorded material at the same time.

This application is a continuation-in-part of application Ser. No. 13/420,889 filed on Mar. 15, 2012, which is a continuation-in-part of application Ser. No. 12/102,001 filed on Apr. 13, 2008, which is a continuation-in-part of application Ser. No. 12/027,257 filed on Feb. 6, 2008.

### COPYRIGHT NOTICE

A portion of the disclosure of this patent contains material that is subject to copyright protection. The copyright owner has no objection to the reproduction by anyone of the patent document or the patent disclosure as it appears in the Patent and Trademark Office patent files or records, but otherwise reserves all copyright rights whatsoever.

### BACKGROUND OF THE INVENTION

1. Field of the Invention

The present invention relates to a device for aiming a digital video recorder. In particular, the present invention relates to a device which can be attached to a digital video recorder and used to aim the digital recorder while continuing to observe the action being recorded.

2. Description of Related Art

With the introduction of digital video recorders, such as camcorders, cell phones/smartphones, digital cameras with video capability, etc., and their ease of use and cost effective price, we now see video recording devices almost everywhere. These new devices are designed for the average user, and hence have concentrated on being user friendly. A trip to a local youth soccer game will quickly show the ubiquity of these video recording devices.

Aiming the digital video recorder (DVR), that is, the framing of the view that will appear on the finished video, is classically done by one of two means. Aiming is conventionally accomplished with use of either an electronic or optical viewfinder. An electronic viewfinder produces a digital image on a screen, much like the finished video product, and it is not uncommon to currently see two inch to three inch LCD screens for viewing the action as it is recorded. The alternative is the older optical system, where, through a series of optical lenses, an approximation or actual view through the lens is accomplished to indicate the framing of what is being recorded. In U.S. Pat. No. 5,099,265, issued Mar. 24, 1992, to Lee, a combination optical and electronic viewfinder is provided, which gives the user the option of which system to use with one device. Many DVRs have both devices as separate viewfinding devices.

A problem with viewfinders in general is that the image is so small on the viewfinder that, while it is possible to frame the action while filming, it is virtually impossible to actually watch the action going on while filming it. Watching a youth soccer game and recording it at the same time can be extraordinarily frustrating, if not impossible.

### BRIEF SUMMARY OF THE INVENTION

It has been discovered that, by positioning an open framed aiming device on a DVR, the open frame can be sighted through or aimed through, such that the view through the open frame is essentially the same as the area the DVR will film. And thus, this allows the user to aim, film, and continue to watch the scene being filmed, as well as watch the adjoining scene not being filmed. With the present device, there is no need to use electronic or optical viewfinders, which make watching the scene being filmed almost impossible.

Accordingly, one embodiment of the present invention is a digital video recorder (DVR) aiming device for use by an individual with a DVR having a lens with a sight line and a viewfinder, the aiming device comprising:
a) a frame having an open portion that can be looked through by the individual, wherein the DVR lens is positioned in one of either;
   i. inside the open portion of the frame; or
   ii. such that the lens sight line is through the open portion of the frame and positioned essentially perpendicular to the sight line of the lens; and
b) a DVR attachment means for removably attaching the device to the DVR wherein the open frame is in a position on the DVR such that upon the individual looking across the top of the DVR and through the open frame and not through the DVR lens or viewfinder one can see essentially what the DVR will film through the lens.

These and other objects of the present invention will be clear when taken in view of the detailed specification and disclosure in conjunction with the appended figures.

Nothing in the drawings is intended to be limiting, and the full scope of the invention is to be interpreted in view of the claims and the specification as further disclosed herein.

### BRIEF DESCRIPTION OF THE DRAWINGS

FIG. 1 is a front perspective view of the present invention with an around the lens attachment means.

FIG. 2 is a front perspective view of the present invention with a hot shoe on digital video recorder body attachment means.

FIG. 3 is a front perspective view of the present invention with wide angle and zoom aiming and lens attachment means.

FIG. 4 is an angled rear perspective of the present invention mounted to the lens of a camcorder.

FIG. 5 is a front perspective of the present invention mounted to the lens of a camcorder.

FIG. 6 is a front view of an embodiment which attaches to the lens and is not a completely enclosed rectangle.

FIG. 7 is a perspective view of an embodiment which attaches to the tripod mount.

FIG. 8 is a perspective of the device attached to a camcorder tripod.

FIG. 9 is a perspective of the device in FIG. 8 with camcorder attached.

FIG. 10 is a perspective view wherein the DVR is a smartphone/cell phone.

### DETAILED DESCRIPTION OF THE INVENTION

It has been discovered that by mounting a framing device on the DVR lens or body, and positioning one's self at the proper distance, that the view through the open frame is essentially the same as the view in the DVR viewfinder. By aiming the DVR using the aiming device, the DVR user cannot only aim the DVR, but can also view the video and the surrounding action at the same time in real time, and not just through a tiny viewfinder.

While this invention is susceptible to embodiment in many different forms, there is shown in the drawings, and will herein be described in detail, specific embodiments, with the understanding that the present disclosure of such embodiments is to be considered as an example of the principles and not intended to limit the invention to the specific embodiments shown and described. In the description below, like reference numerals are used to describe the same, similar, or corresponding parts in the several views of the drawings. This detailed description defines the meaning of the terms used herein and specifically describes embodiments in order for those skilled in the art to practice the invention.

The terms “about” and “essentially” near ±10 percent.

The terms “a” or “an”, as used herein, are defined as one or as more than one. The term “plurality”, as used herein, is defined as two, or more than two. The term “another”, as used herein, is defined as at least a second or more. The terms “including” and/or “having”, as used herein, are defined as comprising (i.e., open language). The term “coupled”, as used herein, is defined as connected, although not necessarily directly, and not necessarily mechanically.

References throughout this document to “one embodiment”, “certain embodiments”, and “an embodiment” or similar terms means that a particular feature, structure, or characteristic described in connection with the embodiment is included in at least one embodiment of the present invention. Thus, the appearances of such phrases in various places throughout this specification are not necessarily all referring to the same embodiment. Furthermore, the particular features, structures, or characteristics may be combined in any suitable manner in one or more embodiments without limitation.

The term “or” as used herein is to be interpreted as an inclusive or meaning any one or any combination. Therefore, “A, B or C” means any of the following: “A; B; C; A and B; A and C; B and C; A, B and C”. An exception to this definition will occur only when a combination of elements, functions, steps or acts are in some way inherently mutually exclusive.

As used herein, the phrase “digital video recorder”, refers to small handheld digital type video recording devices designed for video and, possibly, still photography. They include camcorders, smartphones/cell phones, digital cameras, all with digital recording capabilities. These DVRs consist of a lens that is either fixed, or has either optical or digital zoom, and having permanent or removable lens. Typically, DVRs are fitted with both a digital screen viewfinder as well as some form of optical lens (either through the lens or not) viewfinding system, although smartphones may only have digital screen viewing. These focusing and aiming devices require looking at a very small picture, such that the detail is almost impossible to discern, and it is almost impossible to not have to constantly look up and back, causing very jerky video recordings and making it almost impossible to film a live action event. The current DVRs record a rectangular picture, usually in either a 4:3 format or 16:9 format.

As used herein, an “aiming” device refers to a means for determining what is being shot on the video on a DVR in terms of what is in the recording and what is not. Also called a framing device, the viewfinder is one means of aiming the DVR and seeing exactly what the DVR will be or is recording, but the viewfinder is small and usually difficult to use for video.

As used herein, “open frame” refers to a see-through frame made of bent wire, plastic, wood, alloys, carbon resin, laminate, a composite, or the like, that is shaped proportional to the video picture. The frame can be an entire shape, or partially open, for example, as uprights with an open top. In one embodiment, the frame is a rectangle, but in other embodiments, the frame can be square, circular, oval, trapezoidal, diamond, have additional shapes or the like as desired. Where the DVR has a zoom lens on it, there can be one open frame corresponding to the widest angle, and another open frame positioned concentric with the larger open frame, representing the relationship in sizes for zooming in all the way. In other words, one would aim with the larger frame in wide angle mode and the concentric frame for zoomed in mode. There could be a plurality of concentric open frames, in one embodiment, in a sort of bull's eye dart board configuration. The exact size can easily be determined from the disclosure herein; however, in one embodiment, the frame is as small as three inches across by two inches, or as large as twelve inches across. Manufacture of the device of the present invention is within the skill in the art with the disclosure of the invention in front of them. For example, wire frame devices can be made of stiff wire and bent to shape using conventional means.

The present invention's open frame is attached to a DVR such that, when sighting across the top of the DVR, or at about the level of the DVR lens, one will be looking through the open frame. The general positioning can be seen further in examples of the appended figures for both camcorders and smartphones. One skilled in the art can build a frame for attachment in view of the disclosure herein. The device is attached (removably in one embodiment) to the DVR by attachment to the lens, or by attachment to the DVR body. The lens attachment can be by any convenient means, such as to existing mounts on the DVR, or by clips, framing material, elastic means, Velcro® type hook and loop devices, screw-on means, or the like. The present invention device can also be attached to the DVR body in similar means. An attachment means, in one embodiment, is to provide a hot shoe attachment means, such that the devices attach directly or indirectly to the hot shoe attachment, if there are any on the DVR. In yet another embodiment of the present invention, there is an attachment means wherein the present invention screws into the DVR lens filter threading, or onto a filter screwed onto the lens. In yet another embodiment, there is an attachment means wherein the device attaches to a tripod mount on the bottom of a DVR, as does the DVR on a tripod.

In one specific embodiment of the present invention, the device of the present invention is removably attached, and, in yet another embodiment, the device is not removably attached.

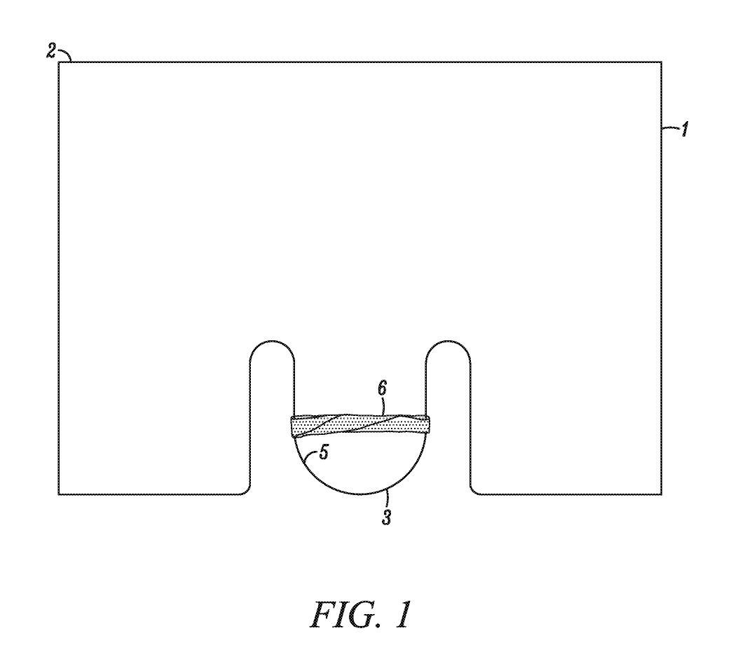

Now referring to the drawings, FIG. 1 depicts a frontal perspective of an embodiment of the present invention. The aiming device 1 consists of rectangular frame 2. Although, as discussed above, different geometrical shapes can be employed. The frame in this embodiment is depicted as a bent wire but, as described above, the frame can be made of any material that achieves the open frame configuration. As can be seen in the drawing, one can easily see through this open wire frame 2.

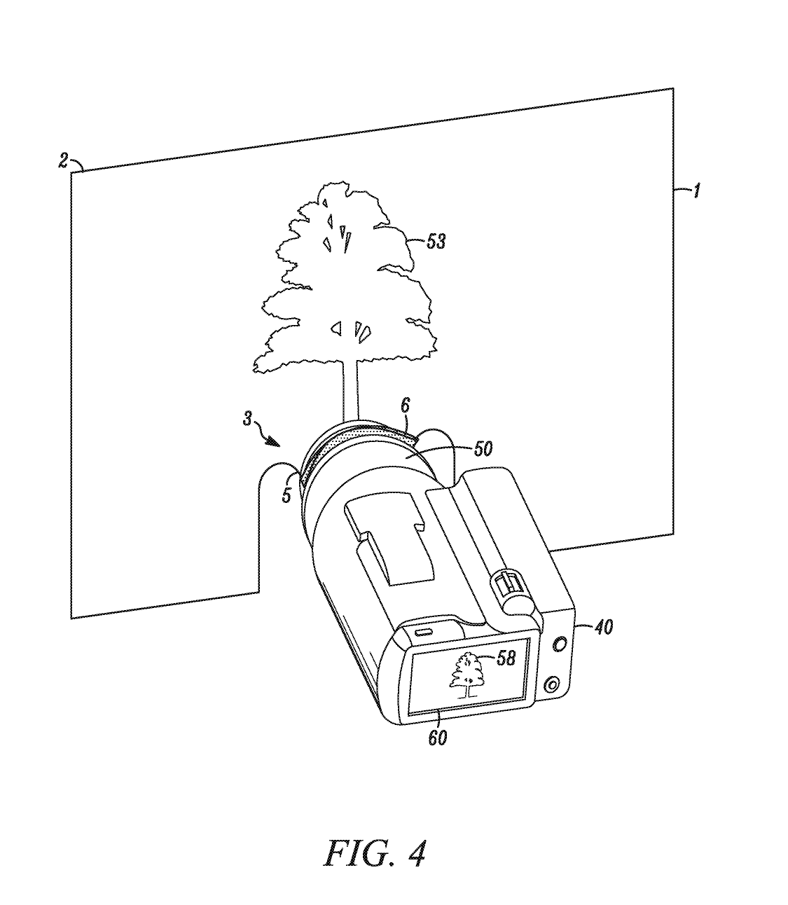

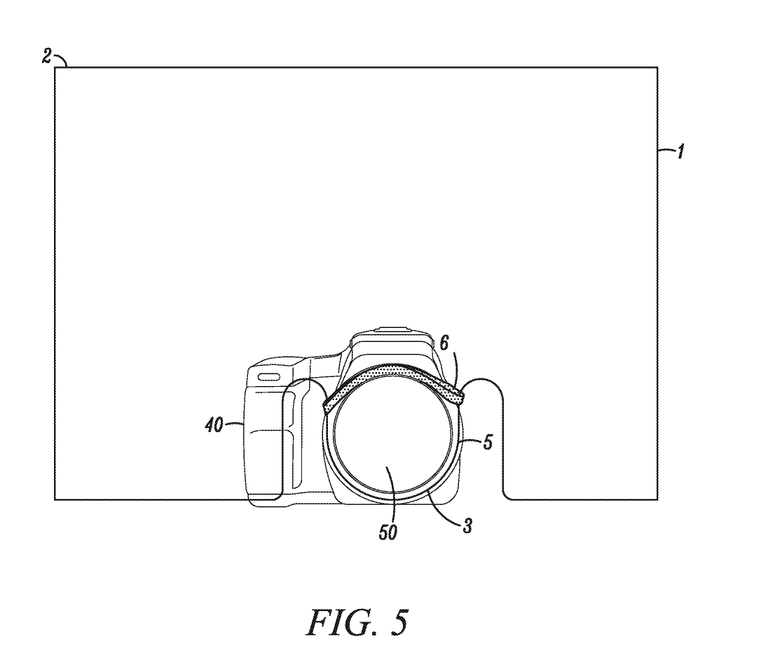

Attachment means 3 to attach the aiming device 1 to a DVR is depicted, in this embodiment, as the bent wire lens attachment 5 and elastic means 6. The elastic means 6, such as an elastic strap rubber band or the like, holds the wire in place, as can be seen in FIGS. 4 and 5. The bent wire 5 portion fits around the lower portion of a DVR lens, and the elastic means 6 around the top of the lens in a tight manner such that the aiming device 1 is held in place essentially perpendicular to the sight line of the DVR lens. As can be seen in this FIG. 1, the frame 2 has a portion of the frame 2 that will be positioned below the level of the lens.

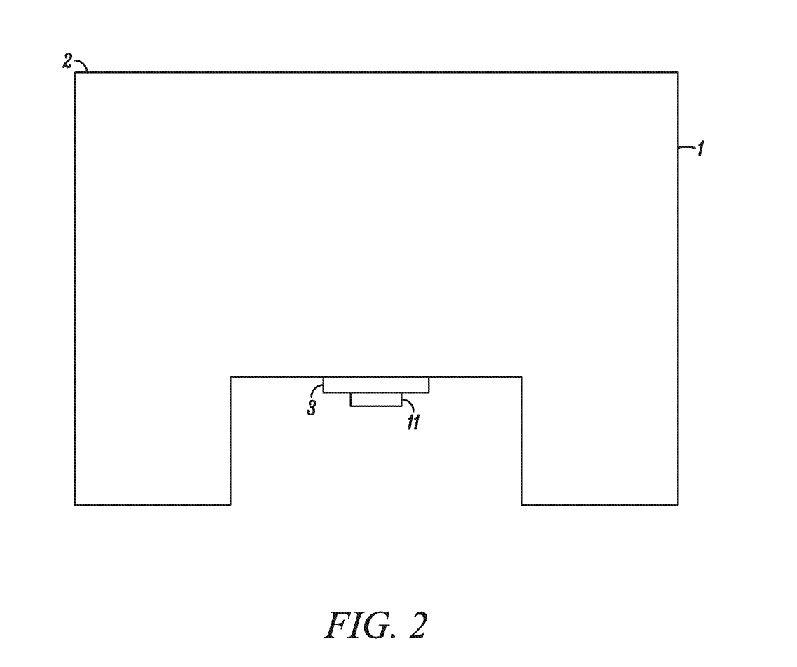

In FIG. 2 there is depicted an alternate frontal perspective view of the present invention. In this embodiment, the aiming device 1 is once again a wire frame 2. However, the DVR attachment means 3 is a hot shoe attachment means 11. This hot shoe attachment means 11 is designed to attach the device 1 by mounting in the hot shoe adaptor in a DVR, if a hot shoe adaptor exists.

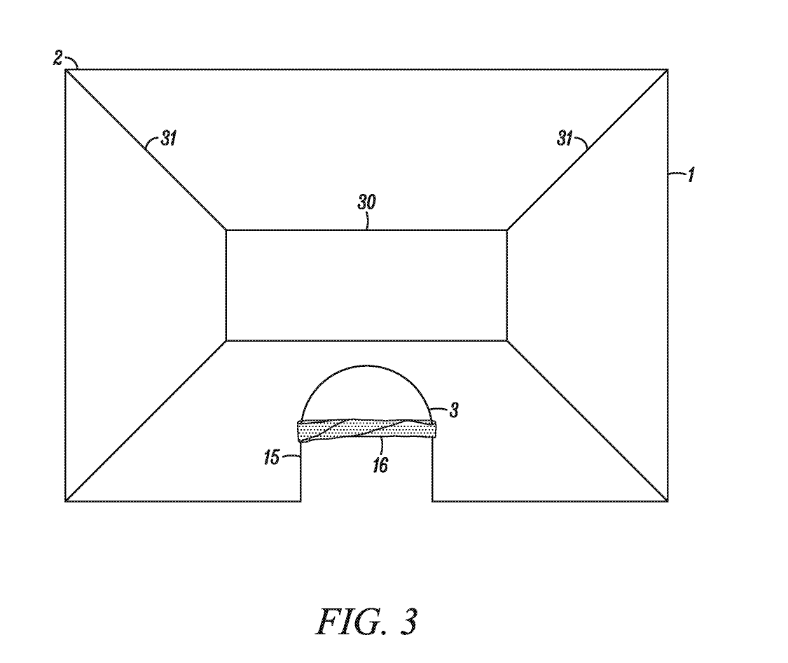

FIG. 3 is yet another frontal embodiment of the present invention. In this view, the aiming device 1 consists of a wire frame 2 which corresponds to aim a DVR in wide angle mode, and an inner wire frame 30, designed to aim the DVR view when the DVR is fully zoomed in. The inner wire frame 30 is suspended concentric to the wire frame 2 by connecting threads 31. By sighting through the appropriate frame, one can aim in the wide angle or zoomed in mode for zoomed positions in between those two, one could approximate the aiming frame relative to the two that exist or, in alternate embodiments, multiple concentric frames similar to frame 30 could be employed.

In FIG. 3 yet another attachment means 3 is depicted. In this embodiment, a top bent wire 15 is employed with a lower elastic 16 to hold the device 1 firmly onto a DVR lens.

FIG. 4 is a rear perspective view of an embodiment of the present invention attached to a DVR 40. Depicted is a removably attached device 1; however, this figure could also represent the non-removably attachment means. In this view, the device 1 consists of the same type of device 1 as depicted in FIG. 1. The wire frame 2 is positioned around the lens 50 of DVR 40. The device attachment means 3, consisting of the bent wire 5 and elastic 6, is shown wrapped around lens 50. As can be seen in this depiction, the view of tree 53 is similar to the view of the tree 58 in LCD viewfinder 60. However, watching the tree 53 through device 1 allows someone to watch activity outside of the frame 2 at the same time as watching what is inside frame 2.

FIG. 5 is a view of the present device, giving a front perspective of the present invention attached to a DVR. The aiming device 1, consisting of frame 2, is the same device 1 shown in FIG. 4 but from the front. The camcorder lens 50 can be seen from the front of DVR 40. The attachment means 3, consisting of the bent wire 5 and elastic 6, are also shown. As can be seen, the attachment means 3 surrounds the lens 50 such that the frame 2 is held in place on DVR 40.

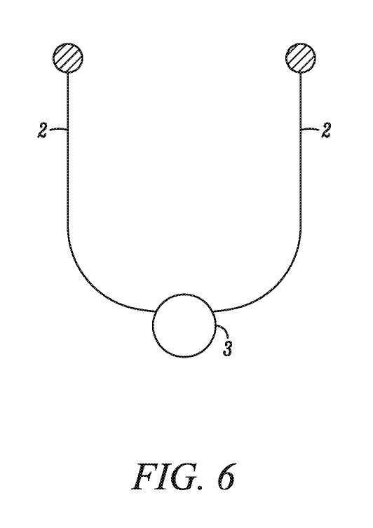

FIG. 6 is another frontal view embodiment of device 1 where the frame is not completely closed. The U shaped frame in this embodiment has camcorder attachment means 3, wherein it can screw onto the lens or a lens cover via a threaded means. As can be seen from this embodiment, the aiming device is designed to generally outline the view being shot. Parts of the frame 2 can be omitted and one can still use the device to aim.

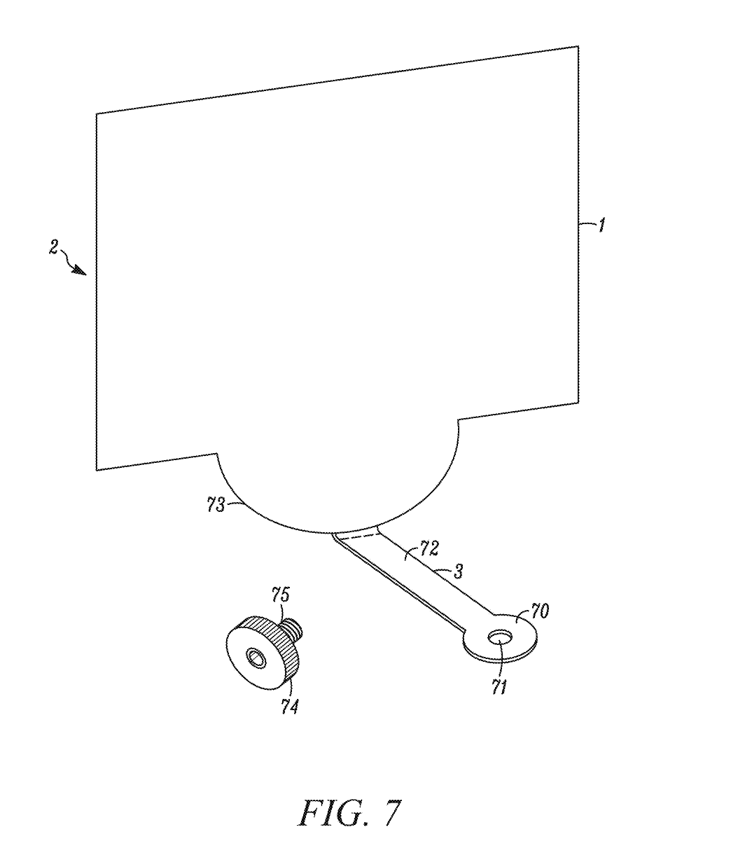

Yet another embodiment wherein the device is attached to the body of the camera as shown in FIG. 7. The aiming device 1 consists of frame 2 and body attachment means 3. The wire frame 2 has lens curvature 73 so that the frame does not interfere with, or touch, a DVR lens, as is the case with the previous embodiment. The DVR attachment means 3 consists of arm 72, which positions the frame in the proper position relative to the mounting hole, camera lens and body. The arm 72 length can be either fixed as shown but, in other embodiments, its length is adjustable to account for different DVRs and their particular design. In yet other embodiments, it's adjustable by otherwise flexing to adapt to offset adaptor mounts. Tripod mount 70 has tripod mount hole 71. A tripod mount screw 74 has its screw 75 passed through hole 71 wherein it can be screwed into the tripod mount screw hole that is present on virtually all DVRs. The screw 74 also has a tripod mount, so that during use of the aiming device 1 mounted in this manner, the DVR can still be mounted on a tripod. This embodiment is used in the same manner as the other embodiments.

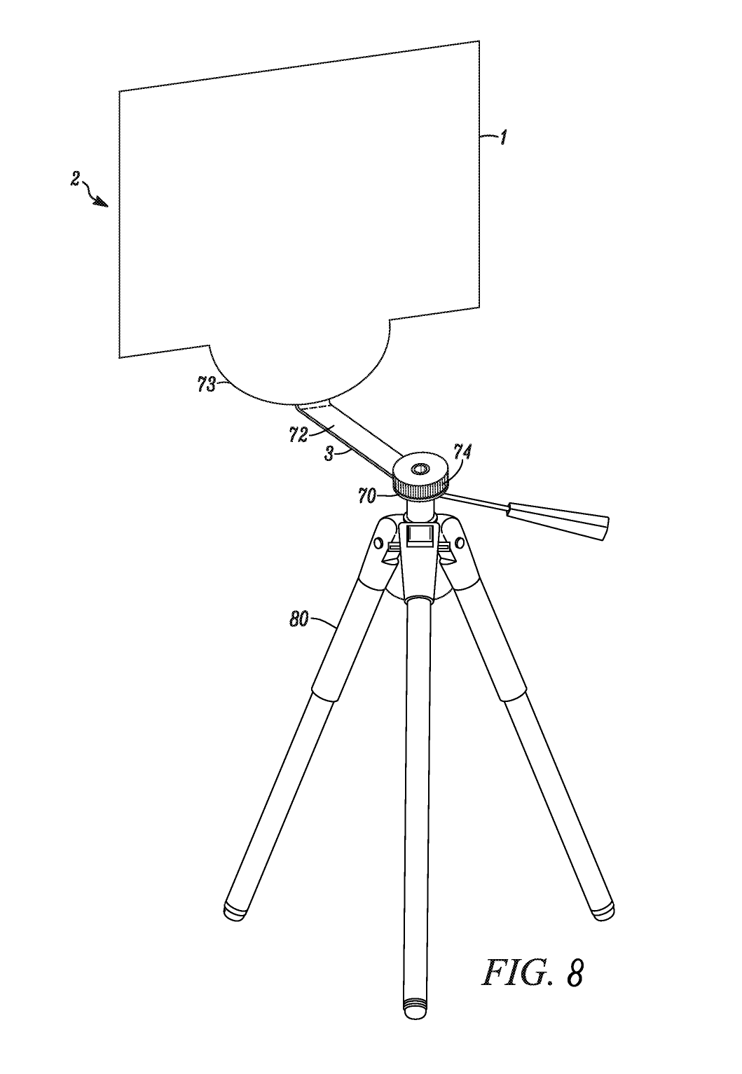

FIG. 8 shows a perspective of the device shown in FIG. 1 attached to a tripod 80 ready to accept a DVR.

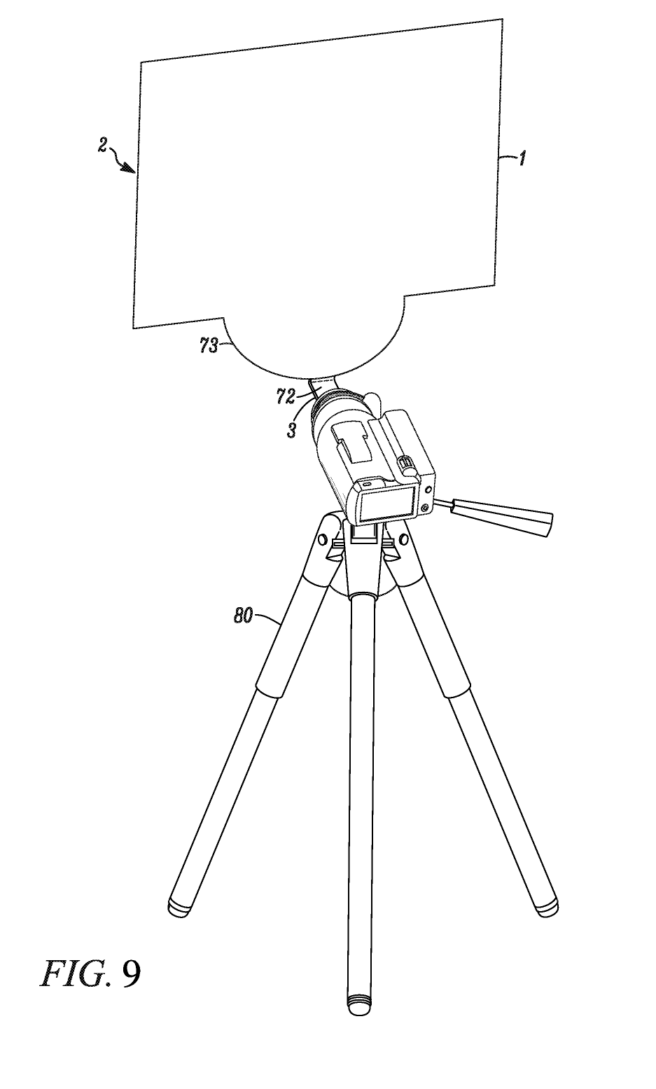

FIG. 9 shows a perspective of the device in FIG. 8 with camcorder attached.

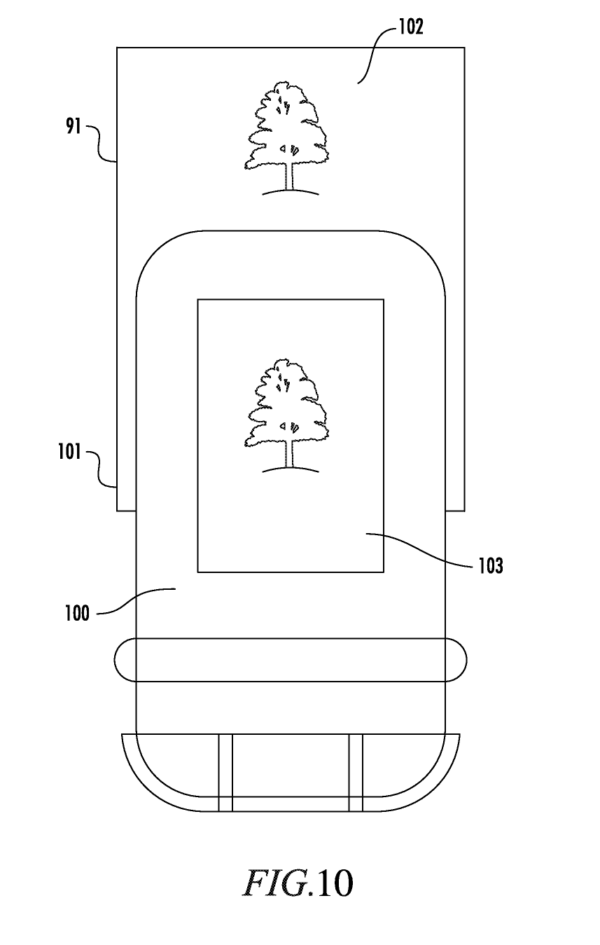

FIG. 10 shows a perspective of the device 91 mounted on a smartphone 100 attached by support wires 101. The support wires 101 can hold the device in front of the phone 100 so that the perspective of the scene 102 is proportional to the video being taken 103.

### Example 1

An aiming device was made as follows: a piece of wire was bent into the shape shown in FIG. 1. The wire was approximately ⅛ inch thick and the frame was approximately 7 inches across and 5 inches high. A rubber band was added as the elastomeric means to hold the device on a DVR. A JVC GZ-MC500U Digital camcorder having a lens approximately 1.5 inches across was selected (and depicted as the camcorder in FIGS. 4 and 5). The frame was fitted on the camera using the attachment means with the rubber band on top of the lens. By holding the camcorder with the frame approximately 12 inches from the eyes, and sighting across the top of the camcorder, the view in the frame is approximately the same as on the camcorder's LCD viewfinder. However the LCD screen is so small that the details of what is being filmed are not able to be readily discerned and one must take their eyes off of the actual scene in order to determine what is being filmed. With the aiming device of the present invention, the filming could be done while watching what is being filmed, as well as having the ability to watch the action around the area being filmed. In an attempt to film multiple balls being thrown, it was impossible to follow the action and film the action using the LCD screen, while with the present invention device, an eye could easily be kept on the action filmed as well as the successive balls being thrown in the present example filming.

### Example 2

A device made according to FIG. 7 is fashioned out of stamped steel or any suitable material. The device is mounted on the screw tripod mount of the DVR described in Example 1. This embodiment of the present invention then does not touch the lens or any active part of the DVR during DVR use.

### Example 3

A device as shown in FIG. 10 is fashioned out of stamped steel and mounted to a Samsung S5 smartphone, with the front lens pointing through the frame.

What is claimed is:

1. A digital video recorder (DVR) aiming device for use by an individual with a DVR having a lens and a viewfinder, the aiming device comprising:
a) a frame having an open portion that can be looked through by the individual, wherein the DVR lens is positioned in one of either;
i. inside the open portion of the frame; or
ii. such that the lens sight line is through the open portion of the frame and positioned essentially perpendicular to the sight line of the lens; and
b) a DVR attachment means for removably attaching the device to the DVR wherein the open frame is in a position on the DVR such that upon the individual looking across the top of the DVR and through the open frame and not through the DVR lens or viewfinder one can see essentially what the DVR will film through the lens.

2. A DVR aiming device according to claim 1 wherein there is at least one additional concentric frame within the frame designed to aim a DVR with a zoom function.

3. A DVR aiming device according to claim 1 wherein the DVR is a cell phone or a smartphone.

4. A DVR aiming device according to claim 1 wherein the aiming device is mounted on a tripod.

5. A DVR aiming device according to claim 1 which is mounted on the DVR.
